(19) United States
(12) Patent Application Publication
(10) Pub. No.: US 2011/0321013 A1
(43) Pub. Date: Dec. 29, 2011

(54) INTERACTIVE ENVIRONMENT FOR TEST CASE GENERATION ASSOCIATED WITH A COMPUTER CODE

(75) Inventor: Ariel RAUNSTIEN, Tel Aviv (IL)

(73) Assignee: QUICKUNIT LTD, Tel Aviv (IL)

(21) Appl. No.: 12/821,291

(22) Filed: Jun. 23, 2010

(51) Int. Cl. G06F 9/44

(52) U.S. Cl. 717/125

(57) ABSTRACT

A method of generating test cases for a given computer code is provided. The method includes: building a method call graph for a computer code under test, wherein the method call graph holds method calls between code elements of the code; presenting code elements having relevancy for testing for a portion of the computer code in response to a selection of the portion, wherein the relevancy is determined using the method call graph; associating test values for code elements in response to selection from a suggested range of test values generated for each selected code element respectively; and generating a test case useable for testing the selected portion of computer code, wherein the test case refers to the selected code elements relevant for the selected portion with the associated selected values, wherein at least one of the building, the presenting, the associating, and the generating is executed by a processor.

### BACKGROUND

1. Technical Field

The present invention relates to the field of software testing, and more particularly, to software testing at small portions of the software code.

2. Discussion of Related Art

High Software Quality is a goal for any organization who builds software. One of the prominent means to that end is a method called Unit Testing, devised in the early 1990's, according to which every small unit of code should be thoroughly tested, independently of its environment.

The reason unit tests have not yet become an industry standard is mainly due to the fact that it means writing much more code for each software project. Many managers do not realize that by having those unit tests—most software projects take less time and cost less, because they allow major changes to be made easily, and you always have an indication if “your software works”, by simply running all of those unit tests. And since learning “how to write unit tests” takes a while—most manages do not even give it a shot. To top it all off—poorly written unit tests may not add quality (test the wrong things), and slow the project down due to excessive maintenance (of the tests code); following (and knowing) best practices in writing tests is crucial.

Those three issues (time to learn, time to create, quality of tests) are being treated using the product. Today, what developers who what to write unit tests do is basically write them—code them. Writing unit tests needs some know-how, so they read into it, buy books, read blogs, read documentation of the testing frameworks, of the mocking frameworks, and then hope for the best. All of that, again, is only done in case the manager allows the developer to spend time on this.

There are two forms of optimization for this writing process—one is a crude code template the developer create for herself, which emits very little code which is only the basic-most of the testing blocks (the test fixture, the test function, or use a project template to create the test project itself).

The other form involves tools which create a basic skeleton of a test for a specific method (as opposed to a generic, empty test), so that default options for values are created, and the developer can then change the code and override those default values with any other code that may fit there.

Microsoft has provided this feature in its 2008 version of Visual Studio Team System, and there are several add-ins for Eclipse and IntelliJ (the two main Java Integrated Development Environments, or IDEs) which provide similar functionalities.

A completely different solution to the hardships of writing unit tests comes from tools for automatic test generation. There are a couple of products which aim to automatically create tests for code, based on methods of code-coverage and expression-solving, to iteratively create more and more tests, so that all the tested codebase may be tested.

Those tools, however, create tests which “pass” whether or not the returned values (or code side effects) are logically correct, since they cannot know what the developer was trying to produce. In this field there's one commercial product by Agitar called AgitarOne, and one product being developed by Microsoft called PEX.

### BRIEF SUMMARY

According to one aspect of the invention, there is provided a method that includes: building a method call graph for a computer code under test, wherein the method call graph holds method calls between code elements of the code; presenting code elements having relevancy for testing for a portion of the computer code in response to a selection of the portion, wherein the relevancy is determined using the method call graph; associating test values for code elements in response to selection from a suggested range of test values generated for each selected code element respectively; and generating a test case useable for testing the selected portion of computer code, wherein the test case refers to the selected code elements relevant for the selected portion with the associated selected values, wherein at least one of the building, the presenting, the associating, and the generating is executed by at least one processor.

Other embodiments may include a system implementing either in hardware, software or combination thereof the aforementioned method and a computer program product implemented as a computer readable medium.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention may be more readily understood from the detailed description of embodiments thereof made in conjunction with the accompanying drawings of which:

FIG. 1 is a high level schematic block diagram of a system, according to some embodiments of the invention;

FIG. 2 is a high level schematic flowchart illustrating a method, according to some embodiments of the invention; and

FIG. 3 is an illustrative display of the user interface, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

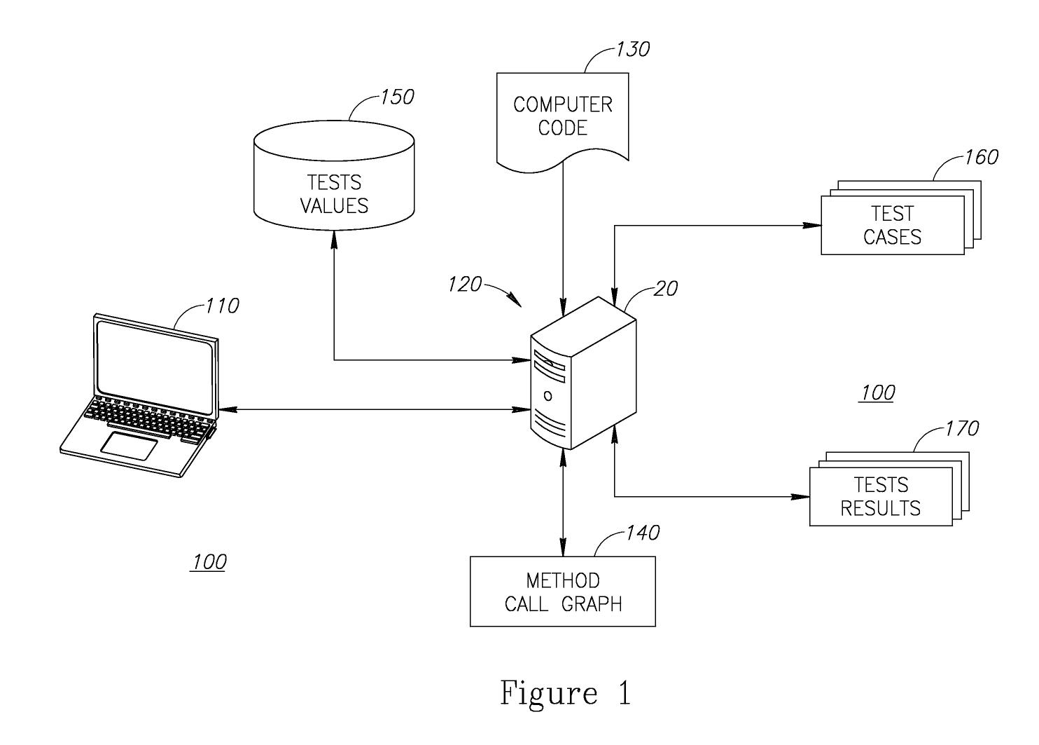

FIG. 1 is a high level schematic block diagram of a system, according to some embodiments of the invention. System 100 may include a graphical user interface (GUI) 110 possibly implemented over a computer terminal 10; and a backend module 120, possibly implemented over a server 20. Backend module 120 may be configured to build a method call graph 140 for a computer code under test 130, wherein method call graph 140 holds method calls between code elements of code 130. GUI 110 may be configured to present code elements having relevancy for testing for a portion of the computer code in response to a selection of the portion, wherein the relevancy is determined by backend module 120 using method call graph 140. Backend module 120 may be further configured to: associate test values 150 for code elements in response to selection from a range of test values suggested over GUI 110 and generated for each selected code element respectively. Backend module 120 may be further configured to generate test cases 160 useable for testing the selected portion of computer code, wherein each test case addresses the selected code elements relevant for the selected portion with the associated selected values.

According to some embodiments of the invention, GUI 110 and backend module 120 may be further configured, in cooperation, to repeatedly present, associate generate with different selections to yield a plurality of test cases, each addressing a different portion of the computer code.

According to some embodiments of the invention, backend module 120 may be further configured to update generated test cases according to later selections in the presenting and the associating, to yield a cross-dependent array of test cases associated with the selected portions of the code. Optionally, backend module 120 may be further configured to compile the test case to yield a corresponding test code. Additionally, backend module 120 may be further configured to run the test code on the portion of computer code to yield test results. Optionally, backend module 120 may be further associated with test results 170

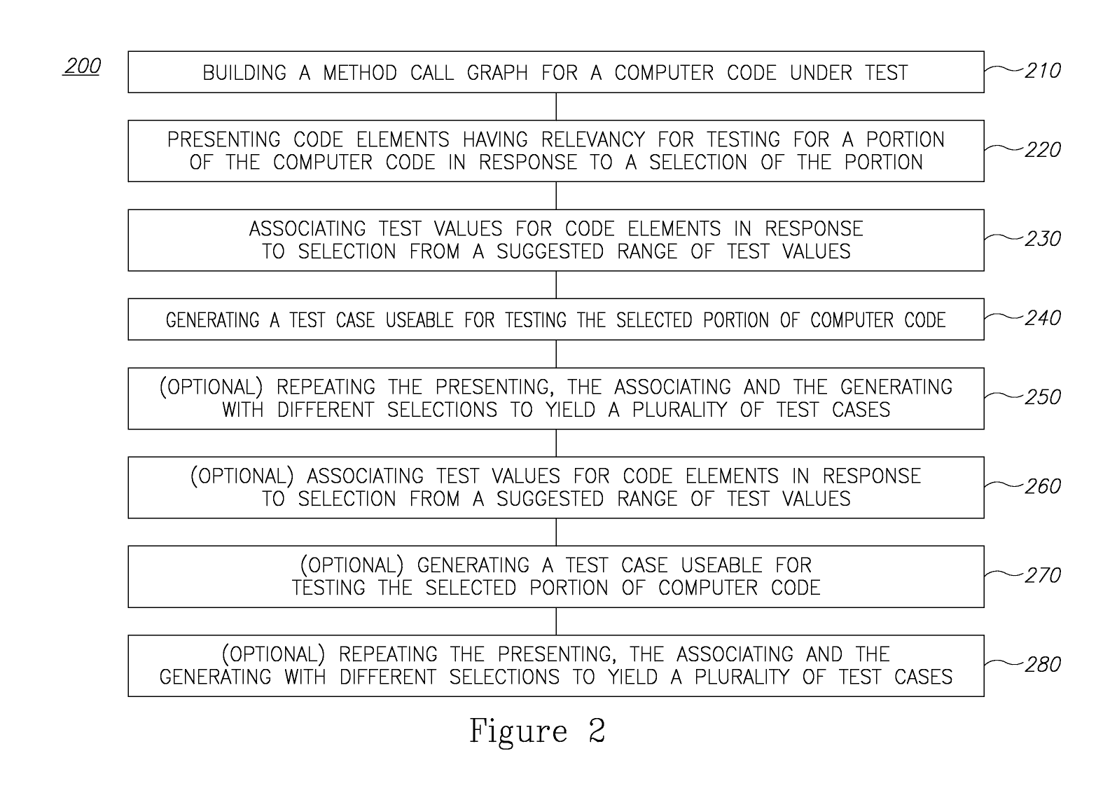

FIG. 2 is a high level schematic flowchart illustrating a method, according to some embodiments of the invention. Method 200 may include: building a method call graph for a computer code under test, wherein the method call graph holds method calls between code elements of the code 210; presenting code elements having relevancy for testing for a portion of the computer code in response to a selection of the portion, wherein the relevancy is determined using the method call graph 220; associating test values for code elements in response to selection from a suggested range of test values generated for each selected code element respectively 230; and generating a test case useable for testing the selected portion of computer code, wherein the test case refers to the selected code elements relevant for the selected portion with the associated selected values 240, wherein at least one of the building, the presenting, the associating, and the generating is executed by at least one processor.

According to some embodiments of the invention, the suggested range of test values is partially generated by analyzing the computer code, and partially from other value sources.

According to some embodiments of the invention, method 200 may further include repeating the presenting, the associating and the generating with different selections to yield a plurality of test cases, each addressing different aspects of the selected portion of the computer code 250.

According to some embodiments of the invention, method 200 may further include updating generated test cases according to later selections in the presenting and the associating, to yield a cross-dependent array of test cases associated with the selected portions of the code 260.

According to some embodiments of the invention, method 200 may further include generating code for the test case to yield a corresponding test code 270.

According to some embodiments of the invention, method 200 may further include running the test code on the portion of computer code to yield test results 280.

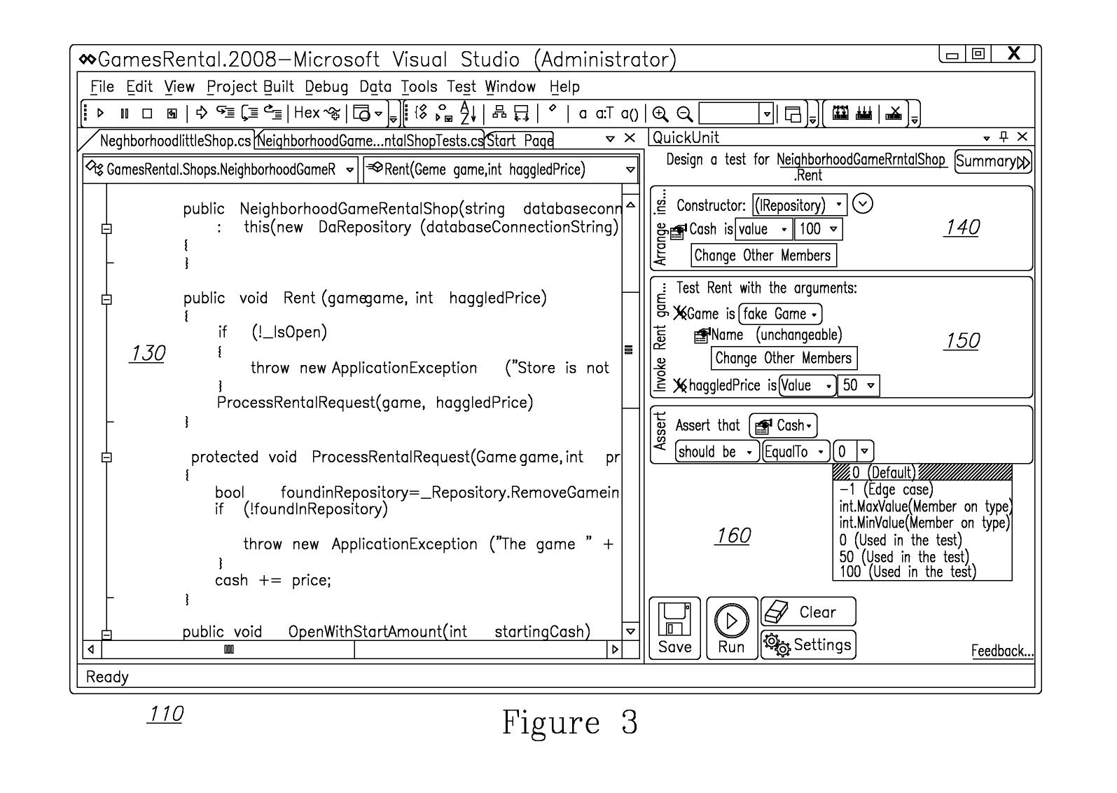

FIG. 3 is an illustrative display of the user interface, according to some embodiments of the invention. There are two main “phases” of operation: all actions required to load the graphical user interface 110 (GUI) for the developer to select values from, and the second one—after the developer chose all the values. There are two main stages in test authoring (first create a scenario, then validate some value), and those stages are reflected in GUI 110 (the actions the user performs, and the actions the products need to perform to show those actions).

Optionally, GUI 110 may comprise an area for the code under test portion 130 showing the selected portion of the code tested, selection areas 140 and 150 configured to present a range of members and respective values to choose from and an area showing the test cases 160 that have been generated based on the selected code, the selected members and the selected values.

For every tested method, the system has several “simple” variables the system needs to get from the user—the method arguments. Those have to be supplied no matter what. Other, not so obvious variables are the arguments for the tested class constructor, any property of that class and static properties anywhere in the system.

The challenge with the aforementioned variables is that there's simply too many of those. When a developer writes code—he or she can simply type the expression, but the product offers a more refined selection. Using a plugin to the Integrated Development Environment (IDE)—the system gets the currently edited code, and analyzes it. From that code the system can extract the method call graph (any methods called from the tested methods; recursively), and that basically entails all the variables which are “interesting” to the tester/developer for that method. In the GUI the system shows all the relevant calls of methods in the scope of an edited class (e.g., only methods from class A may be shown when configuring a parameter of type A; and not all methods of type A, only the ones located on the call graph).

Some of those variables can be manipulated directly (assigned a value), and some have a more complex structure, and cannot be set, so a “Mock Object” may be required, so that it could be programmed to behave in a certain way the developer wants her code to behave under the current test scenario.

There are several differences between existing mock object frameworks; some can change a certain variable and some cannot. The product abstracts the concrete frameworks, and offers the developer to choose based on the selected mocking framework (while showing the options available under other frameworks). The reason for this is that some frameworks are commercial products and some are free.

Constructor arguments are another type of variables which may or may not be interesting; and may even replace a member (property or field) assignment. That relevance resolution is done using more static code analysis, used to determine if that variable is relevant to the test or if it could be omitted from GUI 110.

Consistent with embodiments of the invention, the access to public or private variables is transparent to the user (the required code expression is omitted, and the user is non-the-wiser); except for a “warning sign” the system may place on the UI, which informs the user that such “private” access is both wrong conceptually (testing implementation and not functionality) and would make the test fragile (changing the name would break the test).

The previous sections revolved around the “relevant and changeable variables”. Those variables, however, may have a lot of different values. The system also optimizes that values assignment.

There are four main sources for values that may be presented in test values area 150: Global (items relevant in any testing scenario); Contextual (originating from the behavior and design of the source code); Additive (resulting from analysis of existing tests) and Runtime (run a scenario and look at values). In the Contextual source there are basically two types of values: primitive constants (e.g., the numeric value 123, the string “ABC”, etc.) and static providers (singletons, factories). In the Global source there are two common types of values to send: new instances of complex objects (calling the constructor of an object) and mock objects (or “fakes” or “stubs”). In the Additive source are values suggestions deriving from the analysis of other tests (not the original, functional source code). Such suggestions can be based on code coverage, in a similar manner to other automatic test generation tools. The first four types above are core to the unit test authoring experience, and the product's GUI offers them (when applicable). The others (from the additive source) are ones which most tests writes are unfamiliar with, but could greatly benefit from.

Constant values are gathered from the user's code, and shown as options (this is beneficial if the user has no intimate knowledge with the tested code, and having suggested values is helpful). The “relative relevance” of a given value is shown in GUI 110 and is determined by “distance” from the tested code (constants in the method are more relevant than constants in the class, which are more relevant in other classes in the same namespace, which are more relevant that classes in different namespaces.

Constant values (“ABC”) are “resolved” by scanning the user code for actual Constants declarations (data which is “hardcoded” in the code), and those constants are aliased in GUI 110 with the user-friendly display name located. Again, this resolution is done in accordance to “relative relevance”.

New instances of objects are the complex object's equivalent of “constants”. Constructors are basically memory allocation and initialization functions rolled in one, and the system offers all accessible constructors for the user, defaulting to the one with least parameters.

Since object oriented languages support polymorphism (subclass B of parent A could be assigned to a variable of type A)—the system allows the user to select a new instance only of acceptable subclasses. Those possible types are again sorted by “relative relevance”, and also support another, hierarchical (tree) view.

Mock objects as values are the most interesting values, and most test-specific. The applicability of mocking a variable was discussed previously, and the actual mock values are simple enough—the developer has to simply declare how she wants the mock object to behave (e.g., member X should return Y; method Z should fail). Again, using static code analysis the system can offer the developer to program only the members actually used in the tested method (since the system reviews the call graph), and this is usually a very thin filter. Static providers like factories (or service bags, or containers) and singletons, or even random static methods, could be valid locations. Since the system deals with generic code and it cannot expect to create all the project-relevant value providers—the system allows for an extensibility module for these very values.

Advantageously, using embodiments of the invention, a developer (e.g., a member of a project's infrastructure team) could create custom value providers for the product, complete with the UI and code generation elements, and the system may automatically load them, and show them to the user (other developers) at the correct context. The aforementioned “Static Providers” could (and should) be seen as generic implementations of these “custom” option providers.

Values from the Additive source are the result of test suite analysis. By reviewing all tests generated for one method the system can very simply deduce the usage of values for variables. For highly used values the system may guess one of two options—either other values are insufficiently tested (so the system boosts their visibility to the user, and suggest she tests them too), or that is the most interesting usage scenario (so the system should use that selected value as a default for future tests). A simple question is prompted to the user to figure out which one is it.

The previous section discussed how the product offers the user options to build her scenario for the test. The next section may show how the options for the assertions are created.

The two first sections of value providers exist here too. Global values are the types of assertions available (simple ones like “x=4”, and complex ones like “should throw exception”) provided by the testing framework; and assertions on mock objects (e.g. method “x” should have been called with argument “y”) are provided by the mocking framework plug in. Contextual values are still relevant here (assert that method returned value equal to the const “ERROR_MESSAGE_{—}1”).

Additive providers also offer interesting values (“none of your tests have checked the return value—check it” and “the method can return a const value and no test is created which expects it”). All the above assertion values can be incorporated in the UI, and their visibility boosted accordingly.

The last source of values for assertions is the runtime filler. After the developer created the scenario—the product allows her to run that scenario, and then take the actual returned values and suggest them in the possible values. This mode is especially beneficial for people who want to add tests to existing modules, and for people who'd like to see all the “effected values” of a scenario, and then choose which one is implementation-specific and which relates to functionality.

One of the biggest challenges facing test authors is properly naming their tests. There are several conventions, but the actual act of selecting a name is still the responsibility of the developer. The system gives the developer a “base” name for the scenario and for the assertion (combined—a test name), based on a user-configurable style provider (easily extensible), which results in many times in a unique, descriptive name for the test being created. The developer can, naturally, override (or just tweak) the suggested value before saving.

By having this mechanism of automatic test naming (with style based on user preference) the system can more easily create more than one test, where the situation demands: it is a testing best practice to check only one thing per test, and have several tests per scenario separated to several tests. The system allows doing just that, by allowing selection of multiple checks, but creating several tests (automatically named).

Like adding multiple assertions creates multiple tests—the system also allows for assigning multiple values for a single variable and generates multiple tests for all those values. However, if the user selects multiple values for multiple variables—the result may be generation of a combinatorial set of mixed values. When possible—those tests may be generated as “RowTests” (if the testing framework supports it).

After a test scenario and assertions were selected—the developer can do one of two things: run the generated test (with a selected test runner) or import that test into the test project (using the IDE plugin). Both operations are done using the code that the product generated (and either save the code as text or compile, run and return the result to the developer in GUI 110).

The code generation is done using mechanism with three extensibility points: Language Packs, Frameworks Packs, and Option Packs. All these are “pluginable” to the system, so that support for another language, testing or mocking frameworks or another “option” (discussed in detail below) is just a matter of writing a specialized module for it, and does not require to rebuild the core product.

Code generation for a given test may use the language pack and the testing framework pack to create a test skeleton, then use the option packs (which, in turn, use the language pack for basic operations) to omit all the required initialization code. Expectations and mocking code is done with the use of the appropriate option and mocking framework packs (which, again, use the language pack).

The generated code is, naturally, generated according to testing best practices, combined with specific user configuration. For ease of maintenance (by default)—tests with similar scenarios (which differ only in the “assertion” or “check”) are created so the scenario creation is extracted to another method.

Advantageously, the system and method enable software developers to quickly and simply create unit tests for code they're actively working on. GUI 110 of system 10 shows only a few, contextually relevant options for the developer to choose from, so both novice and veteran programmers could benefit from it. The system and method make use of Static Code Analysis for providing the “options”, and uses Code Generation to persist the developer's selections.

In the above description, an embodiment is an example or implementation of the inventions. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method comprising:
building a method call graph for a computer code under test, wherein the method call graph holds method calls between code elements of the code;
presenting code elements having relevancy for testing for a portion of the computer code in response to a selection of the portion, wherein the relevancy is determined using the method call graph;
associating test values for code elements in response to selection from a suggested range of test values generated for each selected code element respectively; and
generating a test case useable for testing the selected portion of computer code, wherein the test case is based at least partially on the selected code elements relevant for the selected portion with the associated selected values,
wherein at least one of the building, the presenting, the associating, and the generating is executed by at least one processor.

2. The method according to claim 1, wherein at least of the selection in the presenting, and the selection in the associating is performed over a graphical user interface.

3. The method according to claim 1, wherein the suggested range of test values is partially generated by analyzing the computer code, and partially from other value sources.

4. The method according to claim 1, wherein code elements comprises at least one of: functions and classes.

5. The method according to claim 1, further comprising repeating the presenting, the associating and the generating with different selections to yield a plurality of test cases, each addressing different aspects of the selected portion of the computer code.

6. The method according to claim 5, further comprising updating generated test cases according to later selections in the presenting and the associating, to yield a cross-dependent array of test cases associated with the selected portions of the code.

7. The method according to claim 1, further comprising generating code for the test case to yield a corresponding test code.

8. The method according to claim 7, further comprising running the test code on the portion of computer code to yield test results.

9. A system comprising:
a graphical user interface (GUI); and
a backend module,
wherein the GUI and the backend module are in operative association with at least one processor,
wherein the backend module is configured to build a method call graph for a computer code under test, wherein the method call graph holds method calls between code elements of the code,
wherein the GUI is configured to present code elements having relevancy for testing for a portion of the computer code in response to a selection of the portion, wherein the relevancy is determined by the backend module using the method call graph;
wherein the backend module is further configured to:
associate test values for code elements in response to selection from a range of test values suggested over the GUI and generated for each selected code element respectively; and
generate a test case useable for testing the selected portion of computer code, wherein the test case addresses the selected code elements relevant for the selected portion with the associated selected values.

10. The system according to claim 9, wherein at least one of the selections is from menus.

11. The system according to claim 9, wherein the suggested range of test values is generated by analyzing the computer code.

12. The system according to claim 9, wherein code elements comprises at least one of: functions and classes.

13. The system according to claim 9, wherein the GUI and the backend module are further configure, in cooperation, to repeatedly present, associate generate with different selections to yield a plurality of test cases, each addressing a different portion of the computer code.

14. The system according to claim 13, wherein the backend module is further configured to update generated test cases according to later selections in the presenting and the associating, to yield a cross-dependent array of test cases associated with the selected portions of the code.

15. The system according to claim 1, wherein the backend module is further configured to compile the test case to yield a corresponding test code.

16. The system according to claim 15, wherein the backend module is further configured to run the test code on the portion of computer code to yield test results.

17. A computer program product, the computer program product comprising:
computer readable storage medium having computer readable program embodied therewith, the computer readable program comprising:
computer readable program configured to build a method call graph for a computer code under test, wherein the method call graph holds method calls between code elements of the code;
computer readable program configured to present code elements having relevancy for testing for a portion of the computer code in response to a selection of the portion, wherein the relevancy is determined by the backend module using the method call graph;
computer readable program configured to associate test values for code elements in response to selection from a range of test values suggested over the GUI and generated for each selected code element respectively; and
computer readable program configured to generate a test case useable for testing the selected portion of computer code, wherein the test case addresses the selected code elements relevant for the selected portion with the associated selected values.

18. The computer program product according to claim 17, further comprising computer readable program configured to repeatedly present, associate, and generate with different selections to yield a plurality of test cases, each addressing a different portion of the computer code.

19. The computer program product according to claim 18, further comprising computer readable program configured to update generated test cases according to later selections in the presenting and the associating, to yield a cross-dependent array of test cases associated with the selected portions of the code.

20. The computer program product according to claim 17, further comprising computer readable program configured to compile the test case to yield a corresponding test code.
